(19) United States
(12) Patent Application Publication
(10) Pub. No.: US 2011/0117463 A1
(43) Pub. Date: May 19, 2011

(54) BATTERY TEMPERATURE CONTROL METHOD AND ASSEMBLY

(75) Inventors: Sebastian Lienkamp, Budenheim (DE); Horst Mettlach, Mainz (DE)

(73) Assignee: GM GLOBAL TECHNOLOGY OPERATION, INC., DETROIT, MI (US)

(21) Appl. No.: 12/619,750

(22) Filed: Nov. 17, 2009

(51) Int. Cl. H01M 8/04; H01M 10/50

(52) U.S. Cl. 429/433; 429/62

(57) ABSTRACT

An assembly (10) for achieving and maintaining a desired battery operating temperature. A positive thermal coefficient (PTC) resistive element (18) is disposed adjacent a battery (12) in a position to heat the battery.

### TECHNICAL FIELD

The field to which the disclosure generally relates includes methods and assemblies for achieving and maintaining desired battery operating temperatures.

### BACKGROUND

High voltage (HV) lithium-ion batteries are useful in automotive fuel cell applications as well as in automotive hybrid vehicle applications. HV lithium-ion batteries consist of several lithium-ion battery cells connected in series. These lithium-ion battery cells may have a prismatic shape (e.g. pouch type) and utilize liquid or polymer electrolyte. Batteries including lithium-ion polymer cells are known to have greater energy density than other lithium batteries, but are also known to experience strong performance degradation at low temperatures (which is typical for lithium-ion batteries). Performance degradation occurs at low temperatures because the internal resistance increases rapidly and also because the charge current has to be dramatically reduced at sub-zero temperatures to avoid lithium plating that may destroy the battery cells and could cause unwanted reactions. Load must also be completely removed from lithium-ion cells during discharge before the voltage drops below a lower state of charge limit, e.g., approximately 3.0 V per cell (for Mn based cathode material). If a lithium-ion battery is allowed to discharge to its lower state of charge limit and it is not possible to recharge the battery sufficiently, the battery will no longer be serviceable.

Positive temperature coefficient (PTC) heaters include PTC resistive elements that have characteristic anomaly temperatures below which an element will remain at a low, relatively constant level of resistance over a wide temperature range. As the temperature of such a resistive element approaches its anomaly temperature its resistance increases logarithmically. Accordingly, close to its anomaly temperature, even a slight temperature rise in the element causes a dramatic increase in resistance. Additional electrical power supplied to a PTC resistive element will cause the element to self-heat to a high resistance condition. This phenomenon is believed to be caused by a crystalline phase change that takes place in a ceramic component of the element near the anomaly temperature. The change in crystal structure is accompanied by a sharp increase in resistance at crystalline grain boundaries of the crystal structure, resulting in the logarithmic resistance increase. The anomaly temperature of a PTC resistive element can be adjusted in manufacturing by using certain chemical dopents and can be varied between approximately −50° C. and 300° C. In use, when a voltage is applied across an element, the element rapidly heats to and remains at its anomaly temperature. The element remains at the anomaly temperature because the abrupt increase in resistance reduces the amount of heat generated until it equals the amount of power dissipated. In other words, the PTC resistive element reaches thermal equilibrium and, in effect, limits its own temperature to the predetermined anomaly temperature. A PTC resistive element may be in the form of a flexible sheet or film that may be printed onto some type of backing material or directly onto a surface to be heated. The PTC material may be made elastic by blending elastomers.

### SUMMARY OF EXEMPLARY EMBODIMENTS OF THE INVENTION

An assembly is provided for achieving and maintaining a desired battery operating temperature. The assembly includes a battery and a positive thermal coefficient (PTC) resistive element disposed in a position to heat the battery. The PTC resistive element may be configured to have an anomaly temperature generally equal to a desired maximum battery operating temperature to preclude a battery overheat condition.

Also, a method is provided for heating a battery to a desired battery operating temperature. According to this method one can heat a battery to a desired battery operating temperature by providing a battery to be heated, providing a positive thermal coefficient (PTC) resistive element in a position to heat the battery, and supplying electrical power to the PTC resistive element.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a combination schematic block diagram and orthogonal view of a battery temperature control assembly constructed according to the invention with the orthogonal portion of the diagram showing battery cells and resistive elements of the assembly; and

FIG. 2 is schematic block diagram of the battery temperature control assembly of FIG. 1 incorporated into a vehicle electrical power circuit.

### DETAILED DESCRIPTION OF EXEMPLARY EMBODIMENTS

The following description of the embodiment(s) is merely exemplary in nature and is in no way intended to limit the invention, its application, or uses.

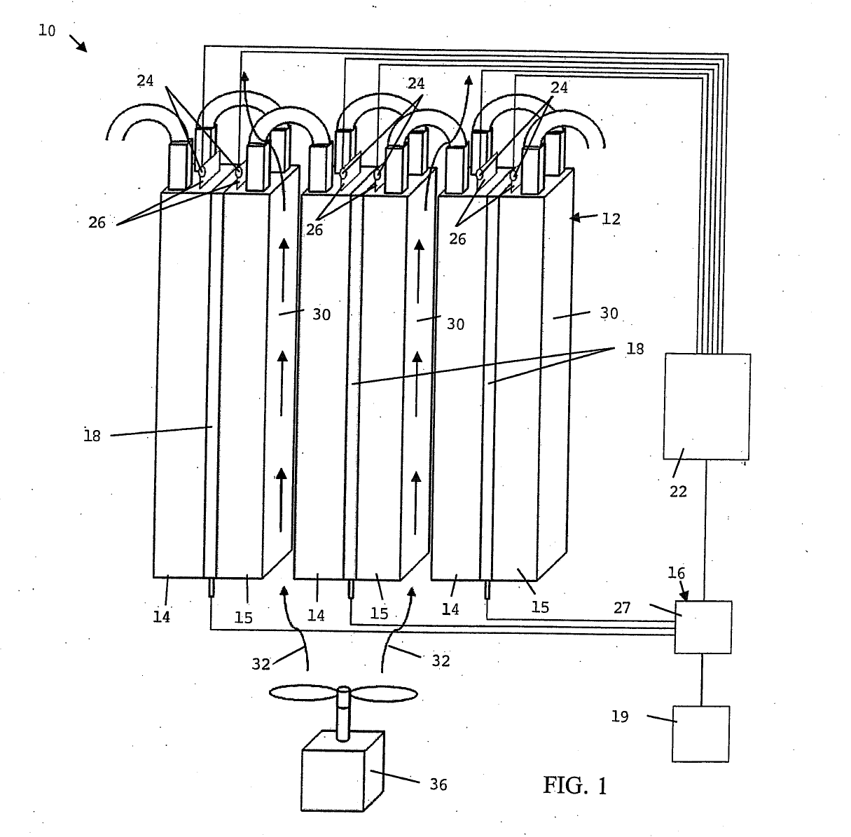

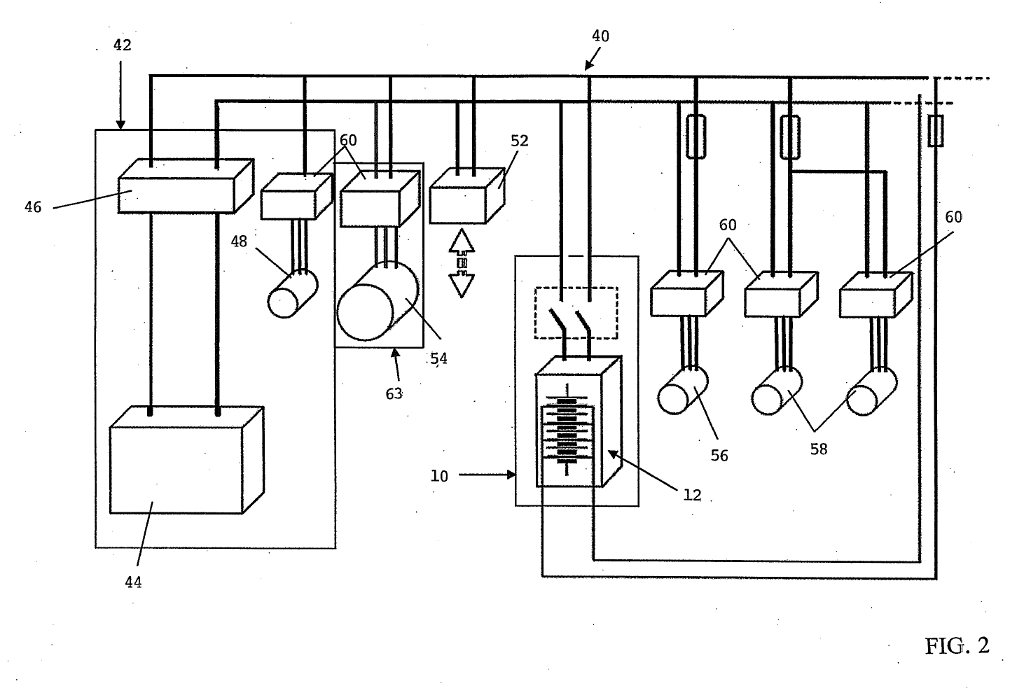

A battery temperature control assembly for achieving and maintaining a desired battery operating temperature as generally shown at 10 in FIGS. 1 and 2. As best shown in FIG. 1, the assembly 10 includes a battery 12 that may comprise a plurality of battery cells 14, 15. The assembly 10 also includes a heater 16 positioned to heat the battery 12. The heater includes positive thermal coefficient (PTC) resistive elements 18 disposed adjacent the respective battery cells 14, 15 in respective positions to heat the cells when electrical power is supplied to the PTC resistive elements 18 from an electrical power source 19.

Each of the PTC resistive elements 18 may be PTC films that may be directly connected to the battery cells 14, 15 by printing or other means known in the art for attaching PTC film to surfaces. The PTC heater films may be a commercially available type such as that used for such applications as rear view mirror heating and designed to operate on a 12 volt power input, or the heater 16 might include a specially designed film configured to operate on higher voltage power such as 300 VDC. As shown in FIG. 1, the PTC resistive elements 18 may be applied or positioned so that there is no gap between the cells and the resistive elements 18.

The PTC resistive elements 18 may have an anomaly temperature generally equal to a desired battery or battery cell operating temperature and less than a maximum battery or battery cell operating temperature. This prevents the PTC resistive elements 18 from continuing to heat the battery 12 or any of the cells 14, 15 of the battery 12 to the point where they reach an overheat condition.

As shown in FIG. 1, the assembly 10 may include a controller 22 and a plurality of temperature sensors 24 that are connected to the controller 22 and may be supported on respective metallic tab portions 26 of the cells 14, 15. Each of the metallic tab portions 26 generally comprises aluminum or another highly thermally conductive substance capable of maintaining a temperature close to an internal cell temperature. Each of the temperature sensors 24 may be disposed in a position to sense the temperature of one of the battery cells 14, 15 and to send a signal to the controller 22 corresponding to the sensed temperature. These temperature sensors may be part of a battery management system.

The PTC resistive elements 18 may also be connected to the controller 22 and the controller programmed to control heat transferred from the PTC resistive elements 18 to the battery cells 14, 15 by controlling electrical power supplied to the PTC resistive elements 18 in response to temperature signals received from the sensors 24. The controller 22 may be programmed to maintain the battery cells 14, 15 within an optimum temperature operating range while the PTC resistive elements 18 may be designed to have a maximum or anomaly temperature generally equal to or less than the battery cell maximum operating temperature. This allows the controller 22 to direct electrical power to the PTC resistive elements 18 without the risk of causing the battery cells 14, 15 to reach temperatures at which the cells might be damaged when, for example, local cell temperatures are higher than those sensed by the temperature sensors.

As shown in FIG. 1 the resistive elements 18 may be connected to the controller 22 through a power switching device 27 such as a relay. The controller 22 may then command the application of power to, or the removal of power from, one or more selected ones of the PTC resistive elements 18 by sending corresponding control signals to the power switching device 27. The power switching device 27 then closes or opens power circuits between a power source 19, and the selected PTC resistive elements 18.

The controller 22 may be programmed to cause electrical power to be supplied to one or more of the PTC resistive elements 18 from an electrical power source 19 when the controller 22 receives signals from corresponding temperature sensors 24 indicating battery cell temperatures below a pre-determined minimum battery cell 14 operating temperature, generally of approximately 20 degrees C. The controller 22 may further be programmed to switch off electrical power from one or more of the PTC resistive elements 18 when the controller 22 receives signals from corresponding temperature sensors 24 indicating that battery cell temperatures have reached a pre-determined normal battery cell operating temperature above approximately 20 degrees C. so that continued heat transfer from the PTC resistive element 18 will not counter or inhibit subsequent attempts to cool a battery temperature that exceeds a pre-determined maximum desired operating temperature.

As shown in FIG. 1, the battery cells 14, 15 are connected to one another in series and may be arranged in pairs with the resistive elements 18 sandwiched between the cells of the respective pairs of battery cells. In other words, each PTC resistive element 18 may be sandwiched between the two cells of one of the battery cell pairs. This allows a single PTC resistive element 18 to conduct heat energy into two cells at once.

As is also shown in FIG. 1, the adjacent pairs of battery cells 14, 15 are generally parallel to and spaced from one another to provide a path for fluid, such as air, to pass between the pairs of cells 14, 15 and cool the cells. In other words, outer sides 30 of the cells 14, 15 can be cooled by cooling air 32 when it's necessary or advantageous to cool the battery, and opposite inner sides of the cells 14, 15 can be heated by PTC resistive elements 18 when it's necessary or advantageous to heat the cells. A fan 36 or other suitable device may be included to propel air between the cell pairs.

The battery 12 may be a rechargeable, high voltage (HV), e.g., 360 volt lithium-ion battery. In other embodiments the battery 12 could be any other suitable type of battery 12, such as a lithium-ion battery or a NiMH battery, which would benefit from heating at low temperatures. Each cell 14, 15 of the battery 12 may be a lithium-ion polymer pouch cell or, in other embodiments, could be any other suitable type of cell, such as a lithium-ion liquid electrolyte or lithium-ion polymer cell, which would benefit from heating at low temperatures.

As shown in FIG. 2, the assembly 10 may be connected in parallel into a vehicle electrical power supply circuit 40. Also connected into the vehicle electrical power supply circuit 40 may be a fuel cell power system 42 including a fuel cell 44, a DC/DC power converter 46 connected to an output of the fuel cell 44, and a fuel cell air compressor motor 48. Other components of the vehicle electrical power supply circuit 40 may include a twelve volt DC/DC alternator 52, an electric traction system (ETS) 53 including an electric traction system drive unit (ETS-DU) 54, as well as one or more vehicle systems including motors powered by the circuit 40 such as an HVAC system motor 56 and any number of electrically powered auxiliary system motors 58, each component being connected in parallel into the vehicle electrical circuit 40. The electrical power 19 for the assembly 10 may therefore include the HV battery 12, the fuel cell 44, the generator 46, the alternator 52, and/or the electric traction system drive unit 54. At low temperature, this arrangement allows the HV battery and/or the PTC resistive elements 18 to help the fuel cell 44 heat up faster by drawing extra power from the fuel cell 44 as required for charging the battery 12 and heating the PTC resistive elements 18 in addition to power drawn by, for example, the electric traction system 53 that alternately propels the vehicle or generates electricity during braking. All such additional power drawn on the fuel cell 44 helps to heat up the fuel cell by causing the fuel cell to generate additional losses.

One or more power inverter modules (PIMs) 60 of the type that provide various power processing functions, may be connected into the vehicle electrical circuit 40. Power inverter modules 60 may be connected between a power 19 (such as the fuel cell 44, the battery 12, and/or the electric traction system drive unit 54) and any or all of the fuel cell air compressor motor 48, the electric traction system drive unit, the HVAC system motor 56, and any electrically-powered auxiliary system motors 58, respectively.

In practice, in low ambient temperature conditions, a desired operating temperature or range of temperatures of a battery 12 can be achieved or maintained by providing a heater 16 comprising a plurality of PTC resistive elements 18 that may be fabricated to each have an anomaly temperature less than or equal to a maximum operating temperature of the battery 12, and/or greater than or equal to a desired operating temperature of the battery 12. The PTC resistive elements 18 of the heater 16 are then provided in respective positions to heat the cells 14, 15 of the battery 12 by incorporating the elements 18 into the battery 12 during fabrication of the battery as described above. An electrical power source 19 such as the battery 12, a fuel cell 44, a vehicle alternator 52, or an electric traction system 54 (during braking) is then provided for the heater 16 as described above. If the temperature of one or more of the cells 14, 15 is determined to be below a pre-determined desired battery operating temperature range, at least the corresponding PTC resistive elements 18 of the heater 16 are then energized by supplying electrical power to at least those corresponding elements 18. Electrical power may then be removed from the PTC resistive elements 18 when the temperature in at least those battery cells 14, 15 reaches the pre-determined desired operating temperature or range of temperatures.

The use of PTC resistive elements 18 in a battery temperature control assembly 10 prevents the heater 16 from causing a battery overheat condition, and, when drawing power from a fuel cell power system 42, helps heat the fuel cell 44 to an optimum operational temperature range for the fuel cell.

The above description of embodiments of the invention is merely exemplary in nature and, thus, variations thereof are not to be regarded as a departure from the spirit and scope of the invention.

What is claimed is:

1. An assembly (10) for achieving and maintaining a desired battery operating temperature, the assembly comprising:
a battery (12); and
a positive thermal coefficient (PTC) resistive element (18) positioned to heat the battery.

2. An assembly (10) as defined in claim 1 in which the PTC resistive element (18) is configured to have an anomaly temperature generally equal to a desired maximum battery operating temperature.

3. An assembly (10) as defined in claim 1 in which:
the assembly (10) includes a controller (22) and a temperature sensor (24) connected to the controller;
the temperature sensor is disposed in a position to sense the temperature of the battery (12) and is configured to send a signal to the controller (22) corresponding to the sensed temperature;
the PTC resistive element (18) is connected to the controller (22); and
the controller is configured to control heat transferred from the PTC resistive element to the battery (12) by controlling electrical power supplied to the PTC resistive element in response to temperature signals received from the sensor (24).

4. An assembly (10) as defined in claim 3 in which the controller (22) is configured to cause electrical power to be supplied to the PTC resistive element (18) from an electrical power source (19) when the controller (22) receives a signal from the temperature sensor (24) indicating a battery temperature below a predetermined minimum battery operating temperature.

5. An assembly (10) as defined in claim 3 in which the controller (22) is configured to switch off electrical power to the PTC resistive element (18) when the controller (22) receives a signal from the temperature sensor (24) indicating battery temperature has reached a predetermined normal battery operating temperature.

6. An assembly (10) as defined in claim 1 in which:
the battery (12) includes at least a first battery cell (14) electrically connected to a second battery cell (15) in series;
the PTC resistive element (18) is sandwiched between the first and second battery cells (14, 15); and
the PTC resistive element (18) is configured to conduct heat energy into
the first and second battery cells (14, 15) when electrical power is supplied to the PTC resistive element (18) from an electrical power source (19).

7. An assembly (10) as defined in claim 1 in which:
the battery (12) includes a plurality of battery cells (14, 15) connected to one another in series and arranged in pairs; and
PTC resistive elements (18) are sandwiched between the cells of the respective pairs of battery cells.

8. An assembly (10) as defined in claim 7 in which the adjacent pairs of the battery cells (14, 15) are spaced from one another.

9. An assembly (10) as defined in claim 1 in which the battery (12) is a lithium-ion polymer battery comprising at least one lithium-ion polymer pouch cell (14).

10. An assembly (10) as defined in claim 1 further including an electrical power source (19) electrically connected to the PTC resistive element and including one or more components selected from the group of power sources consisting of the battery (12), a fuel cell (44), an alternator (52), and an electric traction system (53).

11. An assembly (10) as defined in claim 1 in which:
the apparatus is connected into a vehicle electrical circuit (40); and
one or more circuit components selected from the group of circuit components consisting of a battery (12), a fuel cell (44), a power converter (46), a fuel cell air compressor motor (48), an alternator (52), an electric traction system drive unit (54), are connected into the vehicle electrical circuit (40).

12. A method for heating a battery to a desired battery operating temperature, the method including the steps of:
providing a battery (12) to be heated;
providing a positive thermal coefficient resistive element (18) in a position to heat the battery; and
supplying electrical power to the positive thermal coefficient resistive element.

13. The method of claim 12 in which the step of providing a battery (12) includes providing a battery comprising a lithium polymer pouch cell (14).

14. The method of claim 12 in which:
the step of providing a battery (12) includes connecting the battery to a fuel cell (44); and
the step of supplying electrical power to the PTC resistive element (18) includes providing power from the fuel cell (44) to the PTC resistive element (18).

15. The method of claim 12 in which:
the step of providing a battery (12) includes providing a battery including at least two battery cells (14, 15); and
the step of providing a PTC resistive element (18) includes sandwiching the PTC resistive element (18) between the two battery cells (14, 15).

16. The method of claim 12 in which:
the step of providing a battery (12) includes providing a battery including a plurality of battery cells (14, 15) arranged in pairs, the pairs being spaced from one another; and
the step of providing a PTC resistive element (18) includes providing a plurality of PTC resistive elements (18) and sandwiching each the elements between the cells (14, 15) of each cell pair.

17. The method of claim 12 in which the step of providing a PTC resistive element (18) includes providing a PTC resistive element (18) having an anomaly temperature less than or equal to a maximum operating temperature of the battery (12).

18. The method of claim 12 in which the step of providing a PTC resistive element (18) includes providing a PTC resistive element (18) having an anomaly temperature greater than or equal to a desired operating temperature of the battery (12).

19. The method of claim 12 in which the step of supplying electrical power to the PTC resistive element (18) includes providing electrical power to the PTC resistive element (18) when the temperature of the battery (12) is below a predetermined minimum battery operating temperature.

20. The method of claim 12 in which the step of providing electrical power to the PTC includes providing the electrical power from a power source (19) comprising one or more sources selected from the group of sources comprising a battery (12), a fuel cell (44), an alternator (52), and an electric traction system (53).

21. The method of claim 12 including the additional step of removing electrical power from the PTC resistive element (18) when the temperature of the battery (12) reaches a predetermined desired operating temperature.
